(19) United States
(12) Patent Application Publication
(10) Pub. No.: US 2021/0222596 A1
(43) Pub. Date: Jul. 22, 2021

(54) MOBILE MULTIPLE ENGINE EXHAUST EMISSIONS PROCESSING SYSTEM

(71) Applicant: Eric Todd Passmore, Midland, TX (US)

(72) Inventor: Eric Todd Passmore, Midland, TX (US)

(21) Appl. No.: 16/874,665

(22) Filed: May 14, 2020

Related U.S. Application Data
(60) Provisional application No. 62/962,611, filed on Jan. 17, 2020.

(51) Int. Cl. F01N 3/05; F01N 13/10; F01N 13/18

(52) U.S. Cl. CPC F01N 3/05; F01N 13/1816; F01N 13/10

(57) ABSTRACT

Disclosed herein is a system and methods for the reduction of emissions from multiple stationary industrial diesel engines utilized in Hydraulic Fracturing Operations. Mobile Multiple Engine Exhaust Emissions Processing System (MMEEEPS) is a mobile system which comingles exhaust from multiple stationary diesel engines and processes the exhausts through a mobile Diesel Particulate Filter (DPF). In an embodiment, the DPF is mounted on a trailer for mobility. Exhaust stacks from stationary engines connect via flexible insulated piping to overhead trunk line(s), that can be custom assembled to fit the needs of each application. With the assistance of Variable Speed In-Line Blowers (VSIB) the exhausts are captured and lead to single or multiple manifolds, which lead to the MMEEEPS unit. The MMEEEPS unit can be configured to mount to multiple stationary diesel engines in any configuration while utilizing VSIB to aid in capture of the emissions to be processed through a DPF, resulting in a significant reduction in emissions.

### CROSS-REFERENCE TO RELATED APPLICATIONS

This application claims the benefit under Title 35 United States Code § 119(e) of U.S. Provisional Patent Application Ser. No. 62/962,611; Filed: Jan. 17, 2020, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods for the reduction of emissions from multiple stationary industrial diesel engines. More specifically, the present invention generally relates to systems and methods for the reduction of emissions from multiple stationary industrial diesel engines utilized in Hydraulic Fracturing Operations, which do not currently meet the United States Environmental Protection Agency (US EPA) standards.

### BACKGROUND OF THE INVENTION

Without limiting the scope of the disclosed systems and methods, the background is described in connection with novel systems and methods for the reduction of emissions from multiple stationary diesel engines in Hydraulic Fracturing Operations.

In response to the copious amount of pollutants found in emissions discharged during Hydraulic Fracturing Operations (“Fracking”) by diesel powered engines, a system is needed to reduce these harmful emissions that is both successful and cost-effective.

Currently there is the ability to retrofit each individual diesel engine with an aftermarket Diesel Particulate Filter (DPF), however this method is not only costly but requires excessive upkeep. Each engine can consistently operate at full output for weeks at a time. To ensure that each engine and corresponding DPF is functioning in accordance to required standards would entail continual surveillance.

The present invention relates to the reduction of emissions from multiple stationary industrial diesel engines that do not currently meet US EPA highway engine standards. Particularly aimed at gathering and processing emissions generated from Hydraulic Fracturing Operations, known as Frac'ing in the Oil and Gas industry.

An extraordinary amount of pollutants is emitted during the duration of a Hydraulic Fracturing Operation, the high-pressure pumps are driven by diesel powered engines. These engines which are classified as “off-road” engines and are not required to meet current commercial diesel engine emission standards set forth by the US EPA. Diesel Exhaust Emissions contain diesel particulate matter (Soot), a component that, according to OSHA, “includes soot particles made up primarily of carbon, ash, metallic abrasion particles, sulfates and silicates.” In 2012, the International Agency for Research on Cancer—part of the World Health Organization—classified diesel exhaust as a “known human carcinogen.”—Safety and Health Magazine article 15047. Other pollutants from a diesel engine include toxic gas compounds include carbon monoxide (CO), nitric oxide (NO), nitrogen dioxide (NO2), and sulfur dioxide (SO2). During Hydraulic Fracturing operations the engines can consistently operate at full output for weeks at time, a single Frac operation can emit as much pollutants as a mid-size city produces daily. Across the United States there are hundreds of Frac operations are performed daily. The MMEEEPS can essentially bring a hydraulic fracturing operation from a tremendous polluter to a near zero emission operation.

The current device can not only simplify upkeep in DPF's but can essentially bring a Hydraulic Fracturing Operation from a tremendous polluter to a near zero emission operation.

### BRIEF SUMMARY OF THE INVENTION

Accordingly, it is an object of the present invention to provide a system and method for the reduction of emissions from multiple stationary industrial diesel engines used in Hydraulic Fracturing Operations. It is a further object of the present invention to allow for ease and flexibility in the configuration of the system and the ability to mount varying stationary diesel engines.

The invention addresses the concerns above by accumulating emissions from multiple engines and processing those emissions with the Mobile Multiple Engine Exhaust Emissions Processing System (MMEEEPS). This invention provides an inexpensive option to reduce emissions, rather than retrofitting each diesel engine with an aftermarket DPF, which is an uneconomical option for fracturing companies.

These and other objects of the present invention are achieved by accumulating emissions from multiple diesel engines used in Fracking operations and processing the emissions with the Mobile Multiple Engine Exhaust Emissions Processing System (MMEEEPS).

In an embodiment, the system is comprised of a single or dual overhead 10″ lightweight steel “trunk line” that is suspended over each engine. The trunk line would be supported with an A-frame style stand. The design of the trunk line can take on many configurations, adjusting to the needs of the operation, however it is best represented as a “horseshoe” shape. Each diesel engine in the operation will connect directly to the trunk line through a custom-sized insulated flexible piping from the engine's exhaust pipe. The trunk line will lead to one or more manifolds that then connect to the MMEEEPS via an insulated flexible piping (MMEEEPS connector). This MMEEEPS connector can be placed on the ground surface, allowing the unit to be placed in multiple locations as desired.

The exhaust from the engines will be captured by the flexible piping and lead to the manifolds with the assistance of Variable Speed In-Line Blowers (VSIB). The VSIB will aid in the pushing of exhaust from the manifolds to the MMEEEPS in addition to equalizing and controlling the exhaust pressure in the manifold. An additional VSIB will be mounted on the mobile unit that will assist with the injection of exhaust emissions into a third-party Diesel Particulate Filter (DPF) system. The DPF will be mounted on a drop deck semi truck trailer. The purpose of the DPF is to filter and process all the commingled emissions collected by the MMEEEPS.

To assist with the need for continual surveillance, pressure sensors that will be strategically placed throughout the trunk line will monitor the manifold pressure of the MMEEEPS unit. The information from the pressure sensors will relay operation conditions throughout the trunk line, and in the manifold to the control room. This information can then be analyzed and automatic adjustments will be made to the operation parameters of the VSIB to prevent any damage or an unwanted reduction of efficiency of the connected engines. If it is necessary, multiple VSIB's may be implemented to optimize the system's performance.

The principle function of the VSIB is to equalize/control exhaust pressure in the manifold created from the various engine output parameters. Each trunk line will tie into a single manifold or into multiple manifolds that connect to the MMEEEPS unit. The manifold(s) will connect to the MMEEEPS unit via an insulated flexible hose that can be placed along the surface of the ground which will allow the unit to be placed in any desired position on location. Another VSIB will be mounted on the mobile unit that will assist with the injection of exhaust emissions into the DPF system. Exhaust emissions will be processed through a third-party DPF which is mounted on a drop deck semi-truck trailer. The exhaust gathered from multiple engines can be processed through the DPF and reduce emissions up to 95% in most cases.

Not only does the MMEEEPS eliminate emissions up to 95% in most cases, it allows for a cost-effective and customizable solution to the Fracking industry. The MMEEEPS would be deployed once a Hydraulic Fracturing Fleet is staged in place and remain through the duration of use of the diesel engines utilized to power the Fracking operation.

In summary, the present invention discloses novel systems and methods for the reduction and treatment of emissions from multiple stationary diesel engines.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is the assembled manifold in a horseshoe configuration section of the mobile multiple engine exhaust emissions processing system in accordance with embodiments of the disclosure;

FIG. 2 is a mobile filter detail assembly section of the mobile multiple engine exhaust emissions processing system in accordance with embodiments of the disclosure;

FIG. 3 is a full assembly on a hydraulic fracturing operation section view of the mobile multiple engine exhaust emissions processing system in accordance with embodiments of the disclosure.

### DETAILED DESCRIPTION OF THE INVENTION

Disclosed herein is a novel systems and methods for the reduction and treatment of emissions from multiple stationary diesel engines.

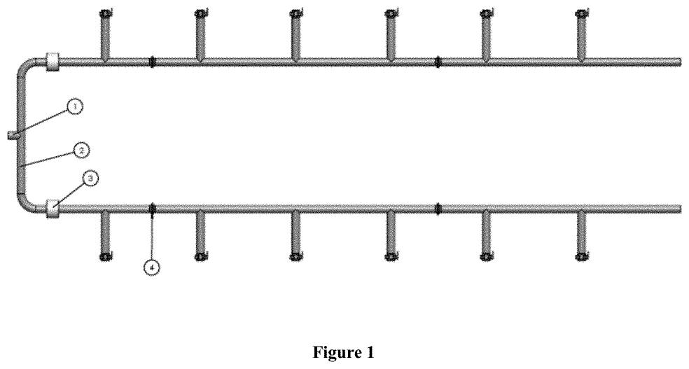

Reference is first made to FIG. 1, an assembled manifold in a horseshoe configuration section of the mobile multiple engine exhaust emissions processing system in accordance with embodiments of the disclosure. In this illustration shown is the main discharge from the modular gathering assembly which will connect to main line to mobile filter 1, the tubing 2, the variable speed blower 3, and the flange 4. The tubing 2 may vary depending on job requirements and can be various sizes and custom configured to meet job requirements. The variable speed blower 3 will assist in regulating pressure in manifold as well as assist in forcing exhaust to/through filter. The flange 4 in embodiments can be bolted or screwed together, flanged to mate tubing and create an air tights seal. In an embodiment, the system is comprised of a single or dual overhead 10″ lightweight steel “trunk line” 2 that is suspended over each engine. The trunk line would be supported with an A-frame style stand. The design of the trunk line can take on many configurations, adjusting to the needs of the operation, however it is best represented as a “horseshoe” shape. Each diesel engine in the operation will connect directly to the trunk line through a custom-sized insulated flexible piping from the engine's exhaust pipe. The trunk line will lead to one or more manifolds that then connect to the MMEEEPS via an insulated flexible piping (MMEEEPS connector). This MMEEEPS connector can be placed on the ground surface, allowing the unit to be placed in multiple locations as desired. In other embodiments, the material used for the line is a rigid material such as but not limited to a polymer, metal, or alloy.

The exhaust from the engines will be captured by the flexible piping and lead to the manifolds with the assistance of Variable Speed In-Line Blowers (VSIB). The VSIB will aid in the pushing of exhaust from the manifolds to the MMEEEPS in addition to equalizing and controlling the exhaust pressure in the manifold.

To assist with the need for continual surveillance, pressure sensors that will be strategically placed throughout the trunk line will monitor the manifold pressure of the MMEEEPS unit. The information from the pressure sensors will relay operation conditions throughout the trunk line, and in the manifold to the control room. This information can then be analyzed and automatic adjustments will be made to the operation parameters of the VSIB to prevent any damage or an unwanted reduction of efficiency of the connected engines. If it is necessary, multiple VSIB's may be implemented to optimize the system's performance.

The principle function of the VSIB is to equalize/control exhaust pressure in the manifold created from the various engine output parameters. Each trunk line will tie into a single manifold or into multiple manifolds that connect to the MMEEEPS unit. The manifold(s) will connect to the MMEEEPS unit via an insulated flexible hose that can be placed along the surface of the ground which will allow the unit to be placed in any desired position on location. Another VSIB will be mounted on the mobile unit that will assist with the injection of exhaust emissions into the DPF system

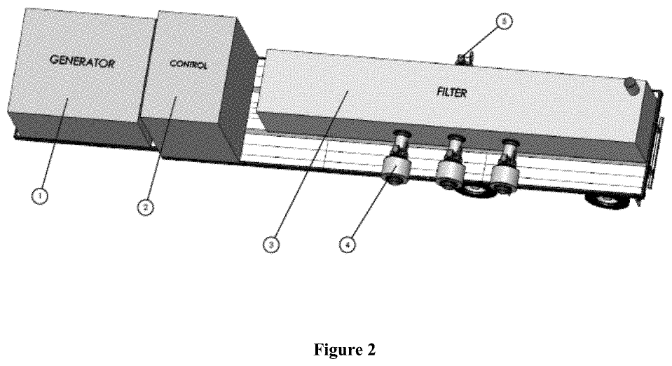

Reference is next made to FIG. 2, a mobile filter detail assembly section of the mobile multiple engine exhaust emissions processing system in accordance with embodiments of the disclosure. Illustrated in this figure is the generator 1, control room 2, DPF filter (exhaust emissions processing unit) 3, variable speed blower 4, and the connection to run additional filters in tandem 5. The generator is used to power the filter, blowers, and operation controls. The control room 2, used to monitor and adjust operating parameters. The control room 2, will also house equipment to monitor exhaust pre and post filter and is used to calculate the amount of exhaust processed. The DPF filter 3 can be of various styles of exhaust filters and in embodiments can be a DPF 3 along with additional catalysis for further processing. The variable speed blower 4, will assist in regulating pressure manifold as well as assist in forcing exhaust to/though filter. As job size increases additional filters can be tied into the system.

An additional VSIB will be mounted on the mobile unit that will assist with the injection of exhaust emissions into a third-party Diesel Particulate Filter (DPF) system. The DPF will be mounted on a drop deck semi truck trailer. The purpose of the DPF is to filter and process all the commingled emissions collected by the MMEEEPS. Exhaust emissions will be processed through a third-party DPF which is mounted on a drop deck semi-truck trailer. The exhaust gathered from multiple engines can be processed through the DPF and reduce emissions up to 95% in most cases.

Not only does the MMEEEPS eliminate emissions up to 95% in most cases, it allows for a cost-effective and customizable solution to the Fracking industry. The MMEEEPS would be deployed once a Hydraulic Fracturing Fleet is staged in place and remain through the duration of use of the diesel engines utilized to power the Fracking operation.

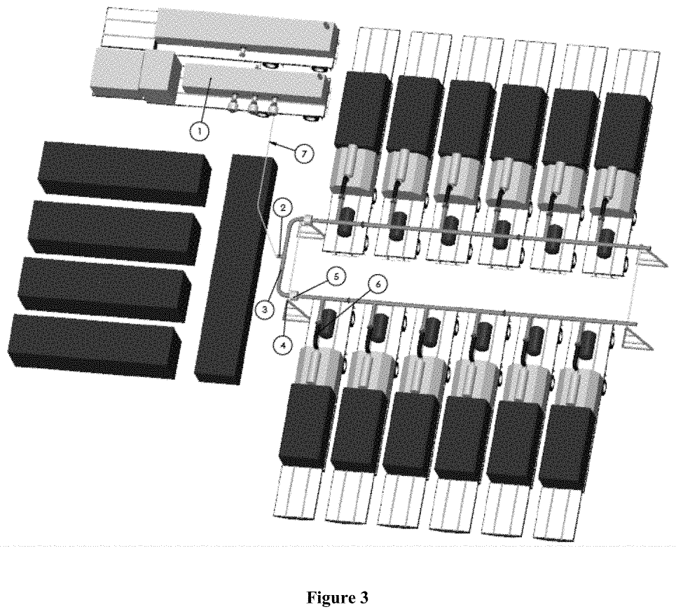

Reference is lastly made to FIG. 3, a full assembly on a hydraulic fracturing operation section view of the mobile multiple engine exhaust emissions processing system in accordance with embodiments of the disclosure. In this view the entire system is seen in full implementation. In this illustration shown is the mobile DPF 1, the discharge header 2, modular gathering assembly 3, frame support stands 4, variable speed blower 5, insulated flexible hoses to connect to exhaust pipe on engine 6, and the line that comes off of gathering assembly that goes to the filter.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods of use disclosed and claimed herein can be made and executed without undue experimentation in light of the present disclosure. While the systems and methods of this invention have been described in terms of preferred embodiments, it will be apparent to those skilled in the art that variations may be applied to the systems and/or methods in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A mobile multiple exhaust emissions processing system comprised of:
piping allowing the connection of one or more engines to the system;
a trunk line wherein said piping is connected to; and
wherein said trunk line is configured to connect to at least one mobile multiple engine exhaust emissions processing system.

2. The system of claim 1, wherein said system is further comprised of variable speed blowers configured to assist in regulating the pressure of said system as well as forcing exhaust to and through the mobile multiple engine exhaust emissions processing system.

3. The system of claim 2, wherein said system is further comprised of one or more manifolds wherein said trunk line connects to.

4. The system of claim 3, wherein said system is further comprised of at least one mobile multiple engine exhaust emissions processing system wherein said manifolds are connected to.

5. The system of claim 4, wherein said trunk line is single 10″ lightweight steel line.

6. The system of claim 4, wherein said trunk line is a double 10″ lightweight steel line.

7. The system of claims 5 and 6, wherein said trunk line is supported over each engine.

8. The system of claim 7, wherein said trunk line is supported with an A-frame style stand.

9. The system of claim 8, wherein said trunk line is a horseshoe shape.

10. The system of claim 1, wherein said piping is insulated flexible piping.
